(19) United States
(12) Patent Application Publication
(10) Pub. No.: US 2015/0122428 A1
(43) Pub. Date: May 7, 2015

(54) ROLLO ASSEMBLY

(71) Applicant: Inalfa Roof Systems Group B.V., Venray (NL)

(72) Inventors: Theodorus Gerardus Franciscus Van Rooij, Venray (NL); Etienne Philippe Marcel André Coiffard, Goch (DE)

(21) Appl. No.: 14/533,675

(22) Filed: Nov. 5, 2014

(30) Foreign Application Priority Data
Nov. 7, 2013 (EP) 13191906.0

(51) Int. Cl. E06B 9/42; A47H 23/00; E06B 9/40

(52) U.S. Cl. CPC E06B 9/42; E06B 9/40; A47H 23/00
USPC 160/264

(57) ABSTRACT

A rollo assembly for a vehicle comprises a winding shaft and a cloth which can be wound onto or off said winding shaft, which cloth is provided with at least one stiffener extending in a widthwise direction of the cloth and is molded thereto. The cloth comprises at least two cloth parts meeting each other at said stiffener, wherein each cloth part, as seen in a longitudinal cross section of the cloth, extends into the stiffener not in line with the remainder of the cloth. The stiffener is made of plastic material and is injection molded to at least said cloth parts.

### BACKGROUND

The discussion below is merely provided for general background information and is not intended to be used as an aid in determining the scope of the claimed subject matter.

Aspects of the disclosure relate to a rollo assembly for a vehicle, comprising a winding shaft and a cloth which can be wound onto or off said winding shaft, which cloth is provided with at least one stiffener extending in a widthwise direction of the cloth and is molded thereto.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

In accordance with an aspect of the present disclosure, the cloth of the rollo assembly comprises at least two cloth parts meeting each other at said stiffener, wherein each cloth part, as seen in a longitudinal cross section of the cloth, extends into the stiffener not in line with the remainder of the cloth and wherein the stiffener is made of plastic material and is injection molded to at least said cloth parts.

Due to the fact that said cloth parts do extend into the stiffener not in line with the remainder of the cloth (thus not defining a single planar plane therewith), the coherence between the cloth parts and the stiffener(s) is improved, thus creating a strong connection between these members. Further injection molding is a rather low cost technique which does not require any finishing steps. The stiffener is effective in keeping the tension across the cloth at a constant level and may avoid the need for side guides for the cloth.

In one embodiment the stiffener is injection molded to said cloth parts only (and thus not to the remaining parts of the cloth). This may promote a proper winding of the combination of cloth and stiffener(s) onto the winding shaft.

Further it is possible that the cloth parts, as seen in a longitudinal cross section of the cloth, extend substantially rectilinearly and each include an angle with the remainder of the cloth of at least 45°. Such an angle further may optimize the coherence between the cloth parts and the stiffener.

It is noted that such an angle can be defined as the virtual angle over which such a cloth part should be rotated (starting from a position in line with the remainder of the cloth) for arriving at its present position. Thus when, for example, both cloth parts include an angle of 45° with the remainder of the cloth, the cloth parts between themselves include an angle of 90° and when, for example, one cloth part includes an angle of 45° and the other an angle of 135° with the remainder of the cloth, both cloth parts will extend in parallel to each other.

In a special embodiment of the rollo assembly, the cloth parts each extend substantially perpendicularly to the remainder of the cloth (that means that for both cloth parts said angle is 90°).

In one embodiment of the rollo assembly the cloth parts over substantially their entire extension engage each other. The advantage of such an embodiment is that plastic material of the stiffener that is injected molded to said cloth parts will not lead to stains in the cloth which are visible from below (generally the position where occupants of a vehicle reside) if said material fully penetrates through the cloth parts.

Although, as stated above, it is possible that the cloth parts engage each other over their entire extension (in other words over their full length), it also is possible that the cloth parts there between define a downwardly open channel. In such an embodiment the cloth parts do not engage each other over their full length.

If such a downwardly open channel is provided, the rollo assembly further may comprise a covering strip having a projection or contour to be received in the downwardly open channel. This may be advantageous from an aesthetical point of view, but the strip also may provide additional stiffness.

In one embodiment of the rollo assembly, both cloth parts are integrally interconnected for defining a single continuous cloth. Basically this means that the cloth extends uninterrupted over its entire length, including the cloth parts (without a visible seam in the cloth). The cloth parts are defined based upon their orientation which differs from the orientation of the remainder of the cloth (because the cloth parts, as stated previously) do not extend in line with the remainder of the cloth).

As an alternative, however, the cloth parts may be parts of two separate cloths which are interconnected in one way or another (which way may be an interconnection caused exclusively by the stiffeners or an interconnection caused by other means in addition to the stiffeners). This allows the use of cloths with differing characteristics, such as different colors or different cloth materials.

When the cloth parts indeed are parts of two separate cloths, said cloth parts may be joined by a single stiffener. As an alternative, however, it is possible that each cloth part has molded thereto a separate stiffener, wherein the separate stiffeners are provided with cooperating locking members for interconnecting the separate stiffeners for defining a combined stiffener. The separate stiffeners each may be molded to the respective cloth part independently, where after both separate stiffeners are brought together for forming the combined, complete stiffener while joining the cloth parts.

In yet another embodiment of the rollo assembly, the stiffener comprises at least two stiffener parts, of which a first stiffener part is molded to the cloth parts and of which the second stiffener part is connected to the first stiffener part by means of cooperating locking members on both stiffener parts. Such an embodiment increases the possibilities with respect to offering the complete stiffener (first and second stiffener part combined) a desired shape.

The stiffener may come in many different forms. For example, the stiffener may have an upper surface and a lower surface each with a straight, concave or convex shape.

In one embodiment of the rollo assembly, the cloth parts at least partly are provided with a blocking material for preventing an unwanted migration of the plastic material of the stiffener during molding. As an alternative, however, it is possible too that the cloth parts comprise openings for the migration of the material of the stiffener during molding. Both embodiments may be helpful in defining the locations where such material will accumulate during the manufacture of the rollo assembly.

It is conceivable that said material is provided on the faces of the cloth parts facing each other and/or on the faces of the cloth parts facing away from each other, depending, among others, on the position of the stiffener (above or below the cloth parts).

The stiffener may be provided with at least one reinforcement member, such as a metal member extending in the longitudinal direction of the stiffener and at least partially embedded in the stiffener. Such reinforcement members may be used to define mechanical characteristics of the stiffener, but also may be used to keep the cloth (or cloth parts) in a desired position while injection molding the stiffener.

When the rollo assembly is intended for use in combination with a curved part, such as a curved interior of a roof of a vehicle, the stiffener in its lengthwise direction (widthwise direction of the cloth) may define a curved shape, preferably un upwardly curved shape. As a result, the cloth may closely follow the inner contour of such a roof.

The stiffener may have two opposite ends provided with slide shoes for cooperation with guide rails extending alongside opposite transverse edges of the cloth. Such guide rails may already be present for guiding an operation beam at a leading end of the cloth, as is known per se, or may be guide rails uniquely provided for said guide shoes. The guide shoes and guide rails in a very effective manner define the position of the stiffeners and thus the position of the cloth (of which, further, the shape in the transverse —widthwise—direction of the cloth is defined by the shape of the stiffeners).

The slide shoes may be integral parts of the stiffener (and thus formed during the injection molding process, for example using a 2K molding technique for achieving slide shoes made of a different plastic material compared to the plastic material of the stiffener), but it is also conceivable that the slide shoes are manufactured as separate parts which are connected to the stiffener afterwards.

### BRIEF DESCRIPTION OF THE DRAWINGS

Hereinafter aspects of the disclosure will be elucidated while referring to the drawing, in which:

FIG. 1 shows a perspective view of a rollo assembly as provided in an open roof construction for a vehicle;

FIG. 2 illustrates a first embodiment of a stiffener in a cross section according to A-A in FIG. 1;

FIGS. 3a and 3b illustrate a second embodiment of a stiffener in a cross section according to A-A in FIG. 1 during assembly and in a completed state, respectively;

FIGS. 4a and 4b illustrate a third embodiment of a stiffener in a cross section according to A-A in FIG. 1 during assembly and in a completed state, respectively;

FIG. 5 illustrates a fourth embodiment of a stiffener in a cross section according to A-A in FIG. 1;

FIG. 6 illustrates a fifth embodiment of a stiffener in a cross section according to A-A in FIG. 1;

FIG. 7 illustrates a sixth embodiment of a stiffener in a cross section according to A-A in FIG. 1;

FIG. 8 illustrates a seventh embodiment of a stiffener in a cross section according to A-A in FIG. 1;

FIG. 9 illustrates an eighth embodiment of a stiffener in a cross section according to A-A in FIG. 1;

FIG. 10 shows a cross section according to B-B in FIG. 1, and

FIG. 11 illustrates a curved stiffener in a perspective view.

### DETAILED DESCRIPTION OF THE ILLUSTRATIVE EMBODIMENTS

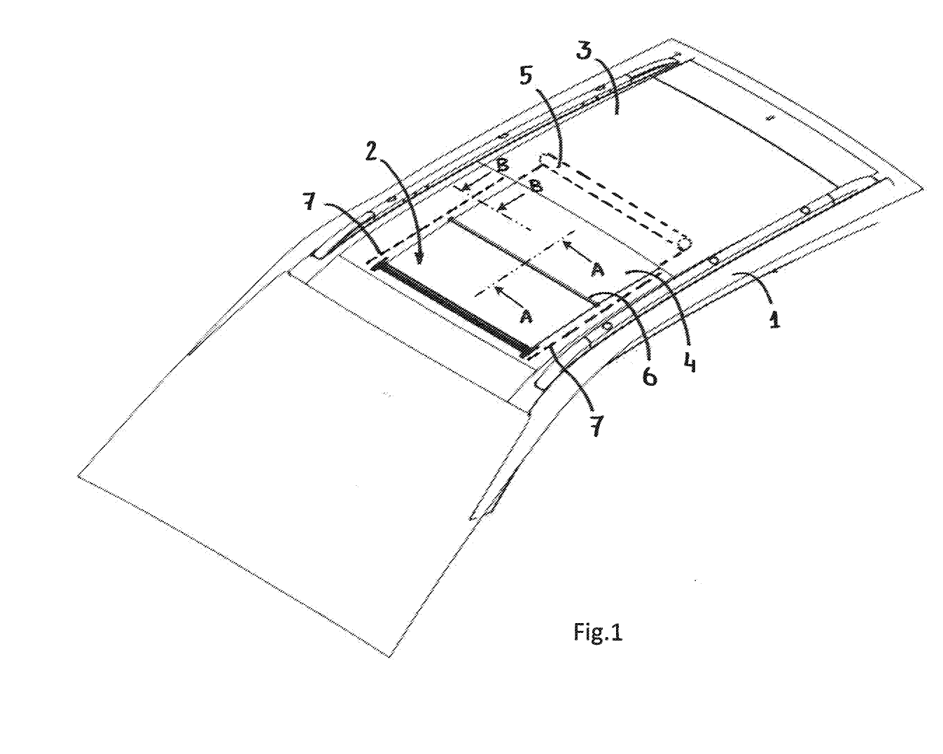

FIG. 1 schematically shows part of an open roof construction of a vehicle, with a stationary roof part 1, a roof opening 2 therein and a movable panel 3 for opening or closing said roof opening. In a manner known per se and not further illustrated in detail, the movable panel 3 is guided for a movement in longitudinal guides along opposite sides of the roof opening 2.

In the roof opening 2 a rollo assembly is positioned which comprises a cloth 4 which can be wound onto or off a winding shaft 5 (only indicated schematically in dotted lines). The cloth 4 is provided with preferably one, and sometimes a number of plastic stiffeners 6 extending in a widthwise direction (transverse to a direction of movement of the cloth 4 when winding and unwinding the cloth 4 on or off, respectively, the shaft 5) of the cloth 4 and injection molded thereto. In a manner to be described later the transverse sides of the cloth 4 are directly or indirectly guided in guide rails 7.

As will appear from the following description the cloth 4 comprises at least two cloth parts 4′ and 4″ meeting each other at said (or each) stiffener 6, wherein each cloth part 4′, 4″, as seen in a longitudinal cross section of the cloth 4, extends into the stiffener 6 not in line with the remainder of the cloth 4. As stated, the stiffener 6 is injection molded to at least said cloth parts 4′ and 4″.

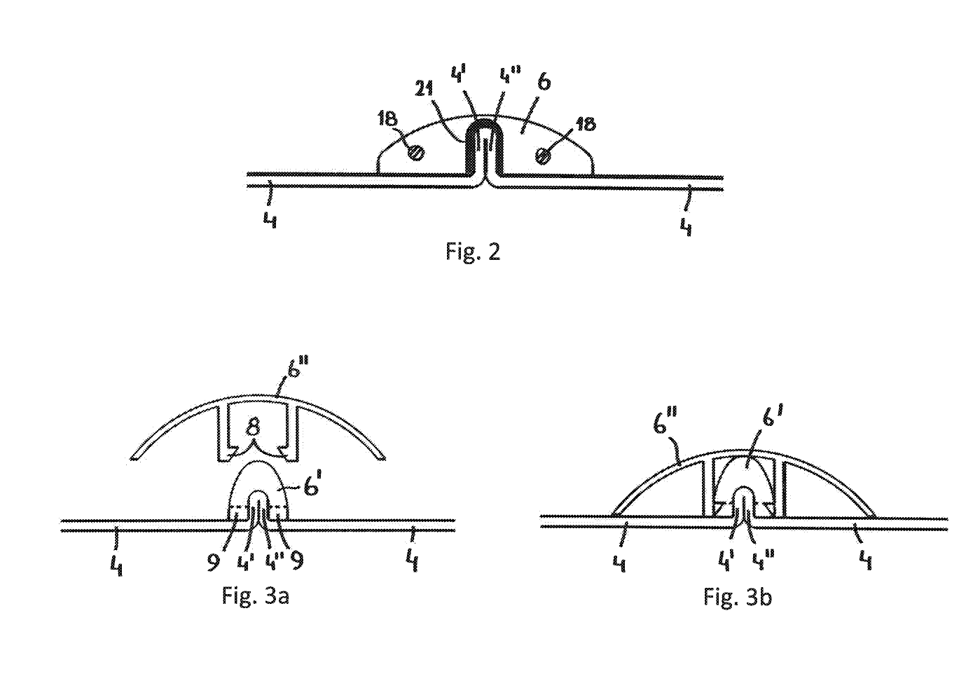

Referring to FIG. 2, a first embodiment is illustrated showing the cloth 4 having two cloth parts 4′ and 4″ which each extend substantially rectilinearly and perpendicularly to the remainder of the cloth 4. Further, in this embodiment both cloth parts 4′ and 4″ are integrally interconnected for defining a single continuous cloth.

The stiffener 6 in this embodiment is a one-piece part injection molded to at least the cloth parts 4′ and 4″, and preferably injection molded only to said parts 4′, 4″ and not to the remainder of the cloth 4 (such as to enable the cloth 4 to be wound closely onto the winding shaft 5).

The stiffener 6 according to the embodiment illustrated in FIGS. 3a and 3b comprises two stiffener parts 6′ and 6″, of which the first stiffener part 6′ is molded to the cloth parts 4′ and 4″ (FIG. 3a). The second stiffener part 6″ thereafter is connected to the first stiffener part 6′ (FIG. 3b) using cooperating locking members (in the illustrated embodiment hooks 8 on stiffener part 6″ and recesses 9 in stiffener part 6′).

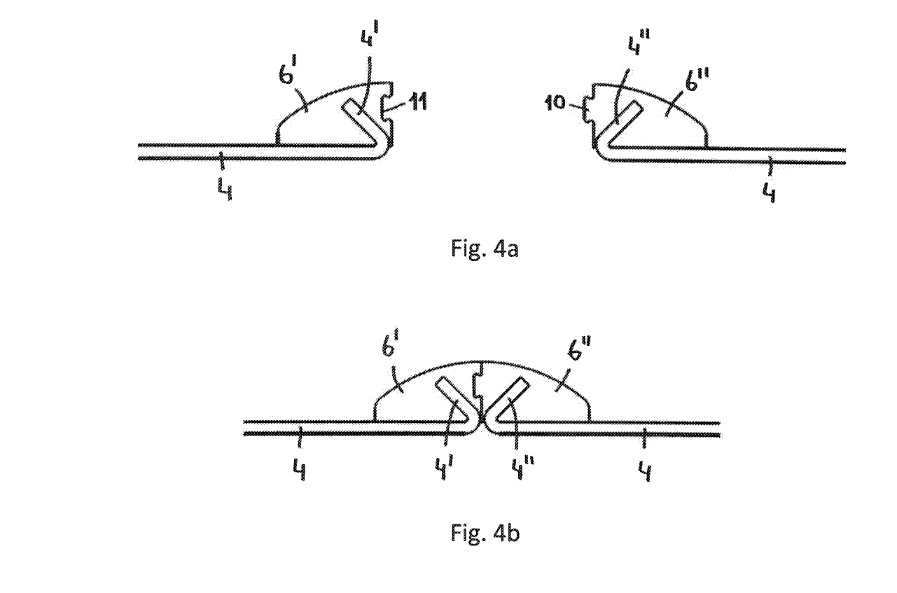

FIGS. 4a and 4b also show a two-part stiffener. However, in this embodiment a first separate stiffener part 6′ is molded to cloth part 4′ and a second separate stiffener part 6″ is molded to cloth part 4″ (FIG. 4a). Thereafter cooperating locking members on the stiffener parts 6′ and 6″ (in this embodiment a projection 10 and a correspondingly shaped opening 11) are used to interconnect the separate stiffener parts 6′, 6″ for defining a combined stiffener (FIG. 4b). It is possible that such an interconnection is permanent or of a type allowing a disconnect at a later stage.

It is noted, that in this embodiment the cloth parts 4′ and 4″ are parts of two separate cloths 4. Further, in this embodiment the cloth parts 4′ and 4″ extend rectilinearly at an angle with respect to the remaining cloths which differs from the situation in FIG. 2. Preferably, such an angle at least should be substantially 45° (wherein such an angle is defined as the angle over which a cloth part should be rotated starting from an original position in line with the remainder of the cloth 4). In the embodiment according to FIG. 4b both angles are about 135°, but it is also possible that both angles differ from each other (a special embodiment featuring such angles that the cloth parts 4′ and 4″ do not extend perpendicularly to the cloth 4 but extend in parallel to each other; in such a case the sum of both angles would be 180°). However, it is also possible that the cloth parts 4′ and 4″ do not extend rectilinearly but have a curved shape, as will appear below.

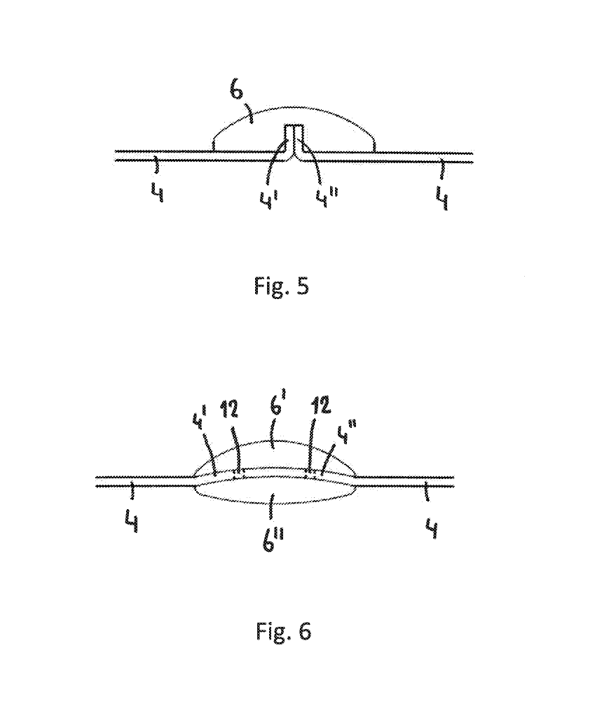

The embodiment according to FIG. 5 resembles the embodiment according to FIG. 2, with the exception that in FIG. 5 the cloth parts 4′ and 4″ are not integrally interconnected but are parts of separate cloths 4.

In FIG. 6 an embodiment is illustrated in which the cloth parts 4′ and 4″ are again integrally interconnected and together define a bow-shaped cloth section. The stiffener comprises an upper stiffener part 6′ and a lower stiffener part 6″ which both are injection molded to the cloth parts 4′ and 4″ (above and below it, respectively). It is possible that passages 12 are provided in the cloth parts 4′ and 4″ through which a material connection is provided between the upper and lower stiffener parts. Such passages 12 also could be applied in other embodiments of the rollo assembly.

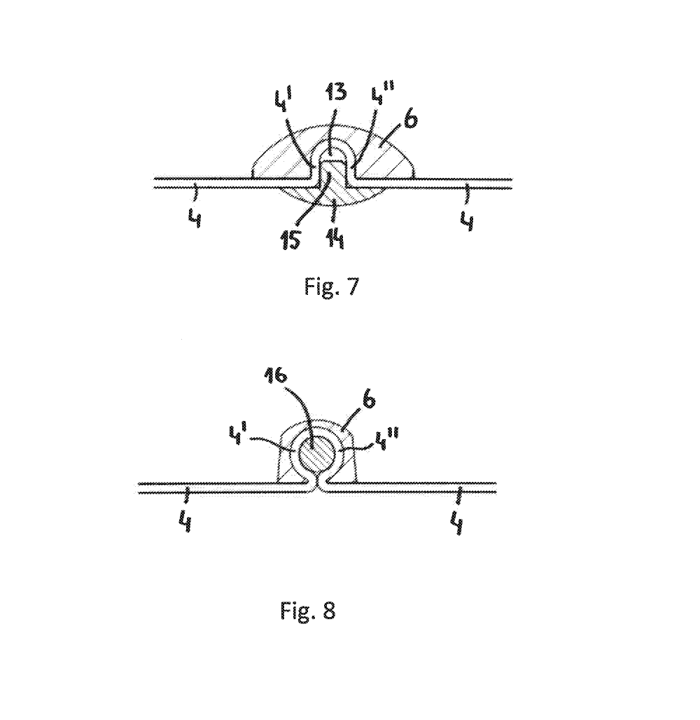

The embodiment illustrated in FIG. 7 features cloth parts 4′ and 4″ which are integrally interconnected, for example being formed from a single type of cloth, and which there between define a downwardly open channel 13. Further a covering strip 14 is provided having a projection or contour 15 to be received in the downwardly open channel 13. Said covering strip 14 may have an aesthetical function but also may provide an additional stiffening.

In FIG. 8 an embodiment is illustrated in which, again, the cloth parts 4′ and 4″ are integrally interconnected such as described above and substantially define a circular shape with an inner cavity in which an additional stiffener part 16 (which may be made of a different material) is received. At least one of the stiffeners 6 and 16 should be injection molded to the cloth parts 4′, 4″. In one specific embodiment the additional stiffener part 16 is made of plastic material too and is injection molded to the cloth parts first, and next the stiffener 6 is injection molded to the cloth parts. The cloth parts 4′ and 4″ also may be permeable or have passages to allow the injection molded plastic material to pass the cloth parts 4′, 4″.

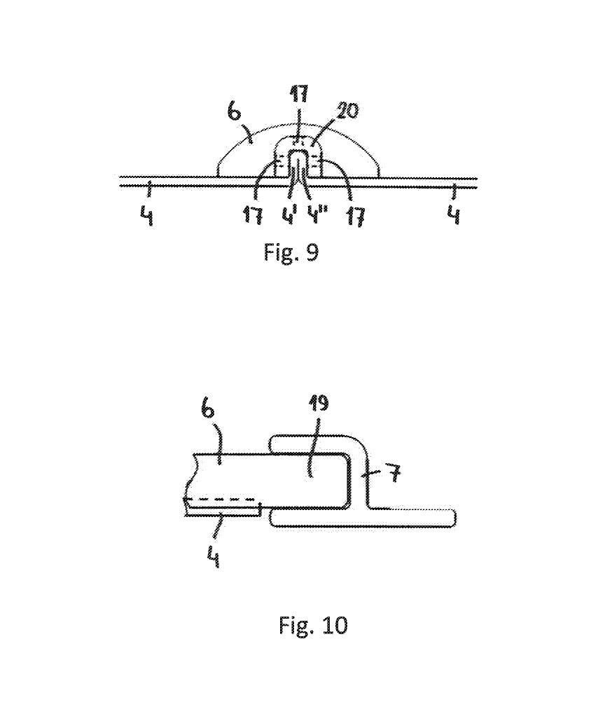

The embodiment according to FIG. 9 shows a stiffener 6 with core part 20 which can be made from a different material (for example a metal). The core part 20 is provided with through holes 17 allowing the stiffener 6 to be molded to the cloth parts 4′ and 4″. The core part 20 can be used to keep the cloth parts 4′, 4″ in a desired position during injection molding (for example by being shaped as a resilient clamp clamping the cloth parts 4′, 4″ together).

It is noted that the stiffener 6 may be provided with at least one reinforcement member, such as two metal members 18 (as shown in FIG. 2) extending in the longitudinal direction of the stiffener 6 and at least partially embedded therein.

It has been shown in FIG. 2 by a thickened line 21 that the cloth parts 4′ and 4″ at least partly may be provided with a blocking material for preventing an unwanted migration of the plastic material of the stiffener 6 during molding (which otherwise could stain the cloth 4). Said blocking material, for example, may be provided locally on the faces of the cloth parts 4′ and 4″ facing each other and/or locally on the faces of the cloth parts facing away from each other. On the other hand, it also may be advantageous in some embodiments that the cloth parts comprise openings for the migration of the plastic material of the stiffener during molding.

Referring to FIG. 10 it is illustrated that the stiffeners 6 may have two opposite ends (only one being shown) provided with slide shoes 19 for cooperation with the guide rails 7 which extend alongside opposite transverse edges of the cloth 4. Although in the illustrated embodiment the cloth 4 ends at some distance from the guide 7 (and thus is indirectly guided thereby through the slide shoes 19), in another embodiment the cloth 4 also could extend into the guide 7 to be guided thereby directly. The slide shoes 19 may be integral parts of the stiffener 6 (and thus formed during the injection molding process, for example using a 2K molding technique for achieving slide shoes 19 made of a different plastic material compared to the plastic material of the stiffener 6), but it is also conceivable that the slide shoes 19 are manufactured as separate parts which are connected to the stiffener 6 afterwards.

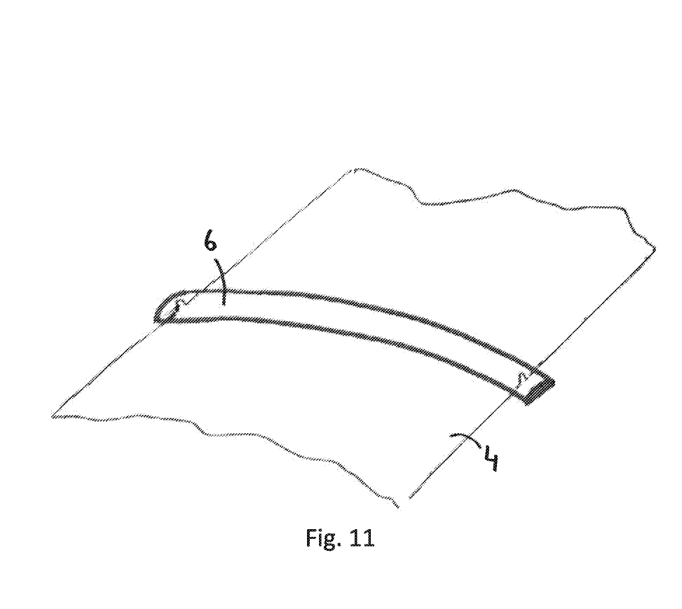

Finally FIG. 11 schematically shows that a stiffener 6 in its lengthwise direction (widthwise direction of the cloth 4) may define a curved shape, for example (substantially) corresponding to a curved inner shape of the roof of a vehicle.

When a cloth assembly is manufactured, the cloth parts 4′ and 4″ are positioned in a mold having a mold cavity, in such a manner that they already assume the desired final position, where after a material for defining the stiffener 6 is supplied (for example by injection molding) into the mold cavity and into contact with at least said cloth parts 4′, 4″.

The mold can comprise two movable mold parts for there between clamping sections of the cloth 4 adjacent the cloth parts 4′ and 4″ before supplying said material in the mold cavity. Further at least sections of the cloth parts 4′, 4″ adjacent the movable mold parts can be provided with a sealing material for preventing an unwanted migration of said supplied material. For example it is possible that said sealing material is supplied over the entire extent of the cloth parts.

It is noted that in the embodiments of the rollo assembly illustrated in FIGS. 2,3a,3b,5 and 9 the cloth parts 4′ and 4″ over substantially their entire extension (or length) engage each other. The advantage of such an embodiment is that plastic material of the stiffener 6 that is injected molded to said cloth parts will not lead to stains in the cloth in general which are visible from below (generally the position where occupants of a vehicle reside) if said material fully penetrates through the cloth parts 4′, 4″.

Finally it is noted that in some embodiments it may be handy if the stiffener 6 is provided with wings extending over parts of the cloth 4 adjacent the cloth parts 4′,4″ and wherein a connection between (the material of) the stiffener 6 only occurs at the said cloth parts 4′ and 4″, and not (or hardly) at said adjacent parts of the remaining part of the cloth 4, such that during winding the cloth 4 onto the winding shaft 5 the cloth 4 can move away from the stiffener 6 for more closely matching the round shape of the winding shaft 5.

Although the subject matter has been described in language specific to structural features and/or methodological acts, it is to be understood that the subject matter defined in the appended claims is not necessarily limited to the specific features or acts described above as has been held by the courts. Rather, the specific features and acts described above are disclosed as example forms of implementing the claims.

What is claimed is:

1. A rollo assembly for a vehicle, comprising a winding shaft and a cloth configured to be wound onto or off said winding shaft, which cloth is provided with at least one stiffener extending in a widthwise direction of the cloth and is molded thereto, wherein the cloth comprises at least two cloth parts meeting each other at said stiffener, wherein each cloth part, as seen in a longitudinal cross section of the cloth, extends into the stiffener not in line with the remainder of the cloth and wherein the stiffener is made of plastic material and is injection molded to at least said cloth parts.

2. The rollo assembly according to claim 1, wherein the stiffener is injection molded to said cloth parts only.

3. The rollo assembly according to claim 1, wherein the cloth parts, as seen in a longitudinal cross section of the cloth, extend substantially rectilinearly and each include an angle with the remainder of the cloth of at least 45°.

4. The rollo assembly according to claim 3, wherein the cloth parts each extend substantially perpendicularly to the remainder of the cloth.

5. The rollo assembly according to claim 1, wherein the cloth parts over substantially their entire extension engage each other.

6. The rollo assembly according to claim 1, wherein the cloth parts there between define an downwardly open channel.

7. The rollo assembly according to claim 6 and further comprising a covering strip having a projection or contour to be received in the downwardly open channel.

8. The rollo assembly according to claim 1, in which both cloth parts are integrally interconnected for defining a single continuous cloth.

9. The rollo assembly according to claim 1, wherein the cloth parts are parts of two separate cloths.

10. The rollo assembly according to claim 9, wherein the cloth parts are joined by a single stiffener.

11. The rollo assembly according to claim 9, wherein each cloth part has molded thereto a separate stiffener, wherein the separate stiffeners are provided with cooperating locking members for interconnecting the separate stiffeners for defining a combined stiffener.

12. The rollo assembly according to claim 1, wherein the stiffener comprises at least two stiffener parts, of which a first stiffener part is molded to the cloth parts and of which the second stiffener part is connected to the first stiffener part cooperating locking members on both stiffener parts.

13. The rollo assembly according to claim 1, wherein the stiffener has an upper surface and a lower surface each with a straight, concave or convex shape.

14. The rollo assembly according to claim 1, wherein the cloth parts at least partly are provided with a blocking material for preventing an unwanted migration of the plastic material of the stiffener during molding.

15. The rollo assembly according to claim 1, wherein the cloth parts comprise openings for the migration of the plastic material of the stiffener during molding.

16. The rollo assembly according to claim 14, wherein said blocking material is provided on the faces of the cloth parts facing each other and/or on the faces of the cloth parts facing away from each other.

17. The rollo assembly according to claim 1, wherein the stiffener is provided with at least one reinforcement member, such as a metal member extending in the longitudinal direction of the stiffener and at least partially embedded in the stiffener.

18. The rollo assembly according to claim 1, wherein the stiffener in its lengthwise direction defines a curved shape, preferably an upwardly curved shape.

19. The rollo assembly according to claim 1, wherein the stiffener has two opposite ends provided with slide shoes for cooperation with guide rails extending alongside opposite transverse edges of the cloth.

20. The rollo assembly according to claim 1, wherein the stiffener is provided with wings extending over parts of the cloth adjacent the cloth parts and wherein the stiffener only is attached to the cloth parts.
